(19) United States
(12) Patent Application Publication
(10) Pub. No.: US 2015/0288771 A1
(43) Pub. Date: Oct. 8, 2015

(54) CONTENT DELIVERY SYSTEMS

(71) Applicant: Knobay Educational Technologies Pvt. Ltd., Chennai (IN)

(72) Inventors: K.R. Ravi KANNAN, Chennai (IN); Vedhagiri PRAKASAM, Chennai (IN)

(73) Assignee: Knobay Educational Technologies Pvt. Ltd., Chennai (IN)

(21) Appl. No.: 14/246,873

(22) Filed: Apr. 7, 2014

(51) Int. Cl. H04L 29/08; G09B 7/00

(52) U.S. Cl. CPC H04L 67/22; H04L 67/06; G09B 7/00

(57) ABSTRACT

The invention provides content delivery systems which comprises a content module that provides downloadable content for offline use wherein the content is personalized for each user accessing the content. The content delivery system comprises usage monitoring module and an evaluation module to monitor and evaluate usage respectively. The system also includes a content personalization module that personalizes content based on the usage.

### TECHNICAL FIELD

The invention relates generally to systems for delivery of personalized electronic contents and more specifically to systems for delivery of personalized contents for offline and online use that is also capable of being monitored and tracked towards usage patterns among other things.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Knobay Educational Technologies Pvt. Ltd. All Rights Reserved.

### BACKGROUND

Content delivery systems designed to impart knowledge and teachings through online means to incumbents and students of one or more subjects are known in the art. These systems require hill-time online access for the duration of learning. However, in a typical learning environment, most of the learning is achieved by studies that are done offline, and only a small portion of learning involves online interaction. The offline modes of learning in a digital age include the liberal use of online reading material such as downloadable materials from web-based sources, electronic readers such as Kindle® or other ebooks, and the like. However, any offline reading is typically unmonitored, and consequently, the teacher is at a disadvantage in not knowing time spent on the material. Hence, the quality of the material provided cannot be assessed for any further possible improvement. Also, any specific topics or sub-topics that need to be focused for a particular student cannot be gleaned through any existing systems. There exists a dire need in the art to provide content delivery systems that are conducive for being used through available digital and other electronic means that can effectively utilize both online and offline use by a student.

### BRIEF DESCRIPTION

In one aspect, the invention provides a content delivery system that comprises a content module that includes downloadable personalizable content for offline access by a user. The content delivery system also includes a usage monitoring module to obtain usage data. Then, it comprises an evaluation module to obtain evaluation results for the user, wherein the evaluation results include usage data. Further, the content delivery system comprises a content personalization module to provide personalized content from the downloadable personalizable content to the user, wherein the personalization is based on the evaluation results from the evaluation module. The content delivery system also includes a storage module to store at least one of the content for offline use, the at least one evaluation criteria, the usage data, evaluation results, or combinations thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagrammatic representation comprising exemplary components of the content delivery system of the invention;

FIG. 2 is an exemplary login page for contributors to the content delivery system;

FIG. 3 is an exemplary landing page for contributors;

FIG. 4 is a screenshot of templates for content creation page;

FIG. 5 is a screenshot of the content creation page;

FIG. 6 is a screenshot for adding questions to assessment page;

FIG. 7 is a screenshot of details of adding questions to assessment page;

FIG. 8a is a screenshot of adding users to a particular content;

FIG. 8b is a screenshot of assigning users and permissions to a particular content;

FIG. 9a is a screenshot for choosing devices onto which content is to be published;

FIG. 9b is a screenshot showing the progress of publishing;

FIG. 10 is a screenshot of all the content available to consume by a user;

FIG. 11 is a screenshot of specific content for reading available on a particular device;

FIG. 12a is a screenshot of adding a text based note to the content;

FIG. 12b is a screenshot of adding a handwritten note to the content;

FIG. 13 is a screenshot of a questions page;

FIG. 14 is a screenshot of a questions page comprising further details;

FIG. 15 is a screenshot of a questions page that includes a text box for providing the answer;

FIG. 16 is a screenshot of an exemplary assessment page for a particular topic;

FIG. 17 is a screenshot of an exemplary analytics page.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

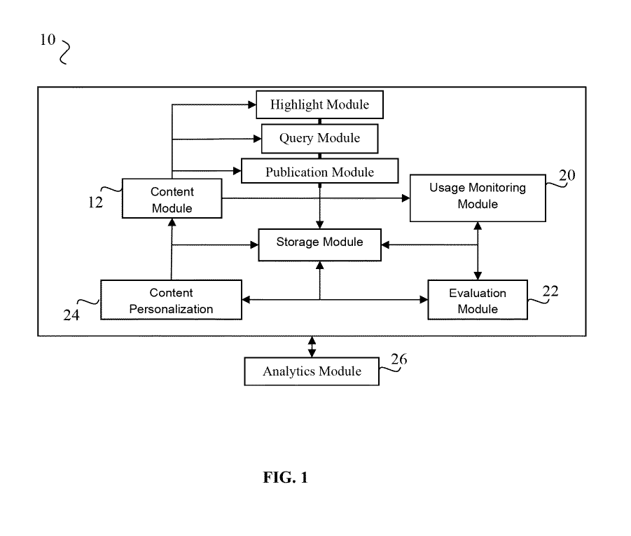

As noted herein, in one aspect the invention provides a content delivery system, depicted in FIG. 1 by numeral 10 that comprises a content module that provides content. FIG. 1 shows the content module represented by the numeral 12. As used herein, content may comprise one or more text, graphic, audio, visual, and/or audiovisual elements. In some examples, the content may include electronic textbooks, electronic pamphlets, electronic workbooks, electronic documents, e-books, and the like. Content further includes questions, hints, answers, and other aspects that go along with a textbook or reading material.

Content may be stored according to any number of or combination of electronic formats including markup language files (e.g., extensible markup language (XML), hypertext markup language (HTML), etc.) Portable Document Format (PDF), ePub (electronic publication-a free and open e-book standard by the International Digital Publishing Forum), Cascading Style Sheets (CSS), and the like, graphics interchange format (GIF), portable network graphics (PNG), joint photographic experts group format (JPEG), exchangeable image file format (EXIF), tagged image file format (TIFF), raw format, bitmap (bmp), scalable vector graphics (SVG), postscript (PS), portable document format (PDF), shockwave flash (SWF), Waveform Audio File Format (WAV) format, Motion Picture Experts Group (MPEG) I, II, III, IV, Apple lossless (m4a), and the like. Content may be one or more pieces, or “portions” of digital content work that may be organized into a coherent whole. Thus, content may be used to refer to both a portion of a content or the entire content.

The content useful in the invention includes any digital content that can be created by at least one contributor using a set of content viewing and editing tools. Contributors of content any individual who submits a contribution to the electronic work and may include editors, proofers, publishers, authors, copy-editors, illustrators, animators, teachers, subject experts, peers, reviewers, students, and the like, and combinations thereof. While the present specification may refer to specific types of contributors (e.g., teachers, editors, etc.) performing various tasks and using the system in various ways, it should be understood that the particular task and/or use of the system may not be limited to only the described type of contributor(s) but may be performed by any contributor. The content is also used by a user, such as, but not limited to, in one exemplary embodiment, a student enrolled for a course, and in another exemplary embodiment, a person enrolled in a fitness routine program and is being monitored by the program managers. Thus, the content may further include authorization checks and balances, such as to see if a particular user has the necessary credentials to access the content, has paid the requisite fees, cleared the basic requirements to enroll for the course, and so on. Access of the content may include a login-password barrier.

The content viewing and editing tools may include tools configured to provide simulated representations of the content in a suitable appropriate digital format, in appearance and function, for each of a plurality of target devices or media. The content delivery system of the invention 10 includes a storage module, shown in FIG. 1 by numeral 14. The storage module may be a combination of a variety of different storage media known in the art. The storage module may include any temporary and/or permanent storage devices known in the art, such as but not limited to, solid-state devices, flash memory devices, etc. One skilled in the art may also appreciate that the storage may be distributed across devices such as a cloud server and a local storage on a particular device (such as a laptop computer or a tablet PC), each of these storage devices holding a relevant set of information required by the user and/or the contributor. For example, the content may be hosted on a suitable location such as a server that may then be accessed through any possible means known in the art, which may include, for example, wired means, wireless means, and the like, and combinations thereof. Alternately, the content may be made available on a cloud server that can then be accessed through known ways. In yet another alternate embodiment, the content may be stored on a local hard drive. All these and other such storage media known in the art are contemplated within the scope of the storage module as described herein.

Methods of getting online include, for example, but not limited to, an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks, or the like.

The content useful in the invention is capable of being downloaded for offline usage onto a suitable device. The content is also capable of being broken into several portions for personalization for a given situation. For example, content may include a text on the subject of chemistry suitable for high school age group that comprises several chapters. This content is capable of being personalized to provide a particular chapter, for example, organic chemistry, for a specific student as personalizable content. Subsequently, this personalized content (in this example, organic chemistry) can be downloaded in a suitable format onto a suitable device or media for offline use. Thus, content as used herein also means the downloadable personalizable content in the invention. It will become obvious to one skilled in the art that the access to the content as long as it is made available on locations such as servers may be restricted and only upon providing appropriate credentials the content may be accessed, whereas once downloaded, the content may or may not include such restrictions or require such credentials for access. However, such credentials such as password protection may still be included in the downloaded content as well.

Further, the content is published using a suitable publication module for producing a plurality of target platform-dependent representations of the content. FIG. 1 shows publication module represented by numeral 16. Each target platform-dependent representation may be for display on a respective one of the plurality of target devices or media. Suitable publication tools to publish and distribute the digital content work to one or more electronic platforms, each having different rendering environments and therefore requiring different versions of the content may be made available. Publication may thus be facilitated through the use of electronic platform profiles that specify requirements for different rendering environments and may include posting the digital content work, in various forms, to an electronic repository where it may be downloaded by end users. In other examples, publication may also include “pushing” an update to the digital content work to users who already have an earlier version of the content.

To facilitate the publication, the publication module 16 is provided profiles for each target device or medium, said profiles specifying capabilities of the respective target device or medium. The target platform-dependent representations of the content are created so as to be compliant with profile-specified capabilities of the respective target device or medium. In some instances, the publication process includes altering the behavior or appearance of media objects, changing the layout of the text (e.g., based upon available screen resolution of the target device), selecting or reformatting images, video or audio to work with the target device, etc. Where necessary, content that may not render on a particular target device may be removed and/or replaced with alternative content, or links to online resources where users may view such content. One or more of the target platform-dependent representations of the content may include cross-platform compatible objects renderable by multiple ones of the target devices.

In further embodiments, the content viewing and editing tools are further configured to permit contributors to transform a static digital representation of the content into a markup language representation of the content by specifying mappings of portions of content from the static digital representation of the content to a plurality of reusable patterns defining the markup language representation of the content. The patterns defining the markup language representation of the content each may define a markup language object portion of the markup language representation of the content and may, in some instances, have various user-selectable configuration options. In this way, patterns can be reused, but personalized to particular requirements of the content. The patterns may be stored in a pattern library. Content creators, editors, and others may browse the available patterns and select same as appropriate for the context in which they are to be used in the content. Patterns may thus be regarded as personalizable content templates that specify component portions of the work. For example, patterns may specify element styles (e.g., font, layout, color, etc.) for particular elements of the work.

The content may be created using a suitable graphical user interface that is configured to permit editors and others to drag and drop patterns from the pattern library, as needed, into appropriate locations in the markup language representation of the content. By selecting portions of a static representation an original source asset (e.g., a PDF version of the work), and dragging the selected portions onto a pattern, the content defined by designated portion of the original source asset is mapped to the pattern and, thus, to the content.

The graphical user interface may, in some instances, be divided into various views, each having one or more panes, different ones of which may be viewable at different times in the creation and editing process. For example, the graphical user interface may include a dashboard, configured to display projects to which a user has access. Each project may represent a different content or portion thereof. The dashboard may provide information maintained by project management tools, which allow users to manage the creation of multiple contents at the same time by setting and managing phases, deliverables and other milestones. Other views may include ones suited for editing, proofreading, inspecting source code, etc. Each view may have one or more panes, arranged in static or personalizable fashions, to permit users to carry our content creation, editing and review tasks. Within the various views, popup windows may be displayed, as appropriate, to allow users to perform certain actions, personalize certain features, and/or specify attributes.

The patterns defining the markup language representation of the content each may be backed by schemas, which define how the markup language representation should be organized. This allows for automated validation of the content. The schemas may be annotated to provide user interface hooks for pattern configuration.

Still further embodiments of the present invention provide an editing tool for creating a markup language representation of the content. The editing tool may be instantiated as a user interface for content creation and editing system and may include a first viewing area for presenting a static digital representation of the content and a second viewing area for presenting a navigator for use in creating the markup language representation of the content from the static digital representation of the content by specifying mappings of portions of content from the static digital representation of the content to patterns defining the markup language representation of the content. The navigator may include a first portion for presenting pattern elements which collectively make up the markup language representation of the content, each pattern defining a markup language object portion of the markup language representation of the content and having a number of user-selectable configuration options.

Responsive to user selection of a pattern element, for example from a pattern library displayed in third viewing area of the user interface, and additional user input, a respective markup language object corresponding to one of the patterns of the pattern library may be inserted in context in the markup language representation of the content. Preferably, the respective markup language object is editable without altering semantic metadata describing content which it includes.

Other tools accessible through the user interface may include a search tool that, responsive to user-designation of a markup language element, results in the display of a set of objects of the content within a single view on a display of a computer system, the view presenting the pages of the content, wherein each of the pages comprises a media object and, unless otherwise specified, all pages of the electronic work are searched for corresponding markup language elements in response to the user designation thereof. The search space may be filtered to specific portions of the content, for example specified chapters, sections, etc. The search may be directed to CSS selectors, plain text, etc., and query results may be stored for collaboration.

Among the editing tools useful in the invention include a What-You-See-Is-What-You-Get (WYSIWYG) visual editor. This editor allows the display of metadata associated with a markup language object of a digital content work, the metadata being displayed in an editable form in context with the markup language object which it describes responsive to a user operation indicating an intent to edit said metadata.

A separate editing tool provides for “code mode” editing of the content. In this instance, direct editing of source code comprising the content is facilitated and a representation of the content is provided so as to allow for real time review of the effects of the source code editing. This form of direct source code editing allows for editing at a very granular level. The code mode editor may be configured to allow for pattern insertion from a pattern library (e.g., via selection from a drop down menu, copying and pasting from a popup window, etc.), ensuring consistent use of style elements, etc. across the entire content.

Still further embodiments of the present invention provide methods of creating a markup language representation of a content that include defining, responsive to user input, a markup language representation of a content as a collection of patterns, each pattern defining a markup language object having a number of user-specified configuration options. Preferably, at least some of the markup language objects include semantic metadata describing respective content included within the objects in terms of its substance rather than its form or appearance. The markup language representation of the content may be published in one or more format-dependent representations for display on respective ones of a plurality of target devices or media.

The content creation, editing and publication processes may be managed by various contributors through an integration component which may integrate the functionality of one or more other components, coordinate various activities between components, may provide a front end interface for users of the system which may integrate data from one or more of these components for presentation to the user, and may provide various content editing and creation tools. The system may also include an asset management component that allows for contributors to submit, manage, and assemble contributions to a digital content work. In some examples, the system may include a content management component that may manage the electronic work once it has been assembled from the various submitted content portions.

In some examples, the process of electronic management of the creation, editing, and publication of content may be managed by, and made available and accessible to, the content contributors through the use of the front end interface provided by an integration component (not shown in FIG. 1). The integration component allows contributors to interact with the various components through a network-based user interface. Additionally, the integration component may coordinate the various other components of the system so as to perform the various operations of the system.

The various components may allow for collaboration where multiple contributors may work on the digital content work simultaneously. The system may include mechanisms to support allowing multiple contributors to work on the content simultaneously including content merge tools. These merge tools may facilitate the merging of contributions from various content creators, editors and other contributors. In some examples, the system may include mechanisms for automatically merging the contributions.

The content delivery system of the invention also comprises a highlight module, shown in FIG. 1 by 18, that is configured to highlight at least a portion of the downloadable personalizable content by the user. Thus, a particular user who wishes to highlight a portion for subsequent use or pose a further query or for any other one or more reasons may highlight that section in an appropriate manner. Highlight module may provide suitable predetermined choices of colors to be used by the user, wherein each color may be ascribed a predefined meaning by each user. Such predefined meanings ascribed to colors may then be shared across users. The highlighting may be done offline, and subsequently, whenever the user gets online, the highlighted portion may be uploaded online to the assigned person or persons for review and/or follow up, such as providing response to a question, or provide an explanation for the highlighted text etc.

The content delivery system of also includes a query module to pose a query by the user, depicted by numeral 20 in FIG. 1. This query module may be invoked from a menu or may be invoked by a special sequence of keystrokes or touch patterns on the interface, and may be in the form of notes or pop up boxes, wherein the user can type or write the query. The query can be posed to any one of another user, a study group, a teacher, a subject expert, a third party assigned by the user, and so on, and combinations thereof. The query module then sends the query to the chosen second user as a suitable response within the content delivery system, such as another popup box, or may send it as an email etc. Other forms of sending such queries may become obvious to one skilled in the art, and are contemplated to be within the scope of the invention.

The query may be made by the user while offline, and once the user comes online, the query may be sent to the specified second user. The query may be sent in a “push” manner, that is sent as soon as the user comes online, alternately, the query may be sent through a click or a keyboard entry from the specific query window invoked by the query module 20.

The content provided herein further includes at least one evaluation criteria, which is used to evaluate at least one user. Exemplary evaluation criteria include questions to be answered by the user, such as multiple choice questions, essay type questions, aptitude questions, and the like, and combinations thereof. The content delivery system of the invention makes available the evaluation criteria such that the responses to it may be provided by the user offline. Subsequently, whenever the user gets online, the response to the evaluation criteria is uploaded onto a suitable location such as the server.

The content delivery system of the invention then includes a usage monitoring module to obtain usage data, depicted by numeral 20 in FIG. 1. Exemplary usage data useful in the invention includes number of minutes spent on a page by the user, number of minutes spent on a given chapter by the user, number of questions answered by the user, number of correct answers provided by the user for each section, number of types of questions attempted by the user, and the like, and combinations thereof. Such evaluation results are monitored and collected through both online and offline modes. Subsequently, whenever the user is connected online, the evaluation results are uploaded onto a suitable location such as the server for further use. The uploading may take place in a “push” manner, or may be achieved by a suitable click or touch or keyboard entry in the appropriate window.

Once usage data is obtained, it can be used for evaluation of the user to provide evaluation results using an evaluation module, shown in FIG. 1 by 22. The evaluation results may then be provided to the teacher, the subject expert, the student, or to other relevant user groups and contributors. The evaluation results may be made available on a suitable graphical user interface, and may also sent through separate means, such as email.

One skilled in the art will also understand that evaluation results may be obtained for a particular user on an individual basis, or alternately, all individual results can be collated together for a group of users. Thus, in some embodiments, when a group of users are taken into account, evaluation results may also include criteria such as average scores, mean scores, median scores, etc. and accordingly, may also include grading on the curve and scaling to reflect such group scores.

The content delivery system then includes a content personalization module, depicted by numeral 24 in FIG. 1, to provide personalized content from the downloadable personalizable content to the user, wherein the personalization is based on the evaluation results from the evaluation module. For example, if the evaluation results show that a particular user spent less time on a particular chapter, or a user obtained less correct answers in a given section or chapter, then the personalization module provides that particular section or chapter to the user. In another exemplary embodiment, if a user obtain above average correct answers for a particular section, the personalization module may provide an advanced chapter on that same topic to reflect the knowledge, interest and enthusiasm shown by the user in that particular area of study. The personalized content may then be provided to the user through a website or a downloadable file from a server, or as an email attachment, etc. The personalized content may further be pushed onto the content delivery system for a given user. The storage module may be used to store all relevant aspects of data described herein, such as but not limited to, the content, the evaluation criteria, the usage data, the evaluation results, etc.

The content delivery system 10 further comprises an analytics module shown in FIG. 1 by the numeral 26. The analytics module may be used to analyze all the available data to provide analytical information for a variety of different purposes. Some exemplary uses of analytical information include finding maximum usage period of content within a 24 hour time period, the most preferred day of the week to respond to evaluation criteria, the most commonly made mistakes by users, the specific portion of content that poses greatest problems to users, the most commonly posed queries, and the like, and combinations thereof.

In various embodiments, the content delivery system of the invention, and each of the individual components described herein may be a hardware-implemented module that is implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of modules described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).) Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC). The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

One skilled in the art will also recognize that the modules may be configured to work with existing content providing products that are readily commercially available. For example, certain modules of the invention described herein may be configured to work with ebooks or Kindle® or other such existing readers, so as to provide a smooth user experience, such that the user may be enabled to use already preexisting applications in the preferred device. Other such variations will also become obvious to one skilled in the art and is contemplated to be within the scope of the invention.

### Exemplary Content Delivery Systems

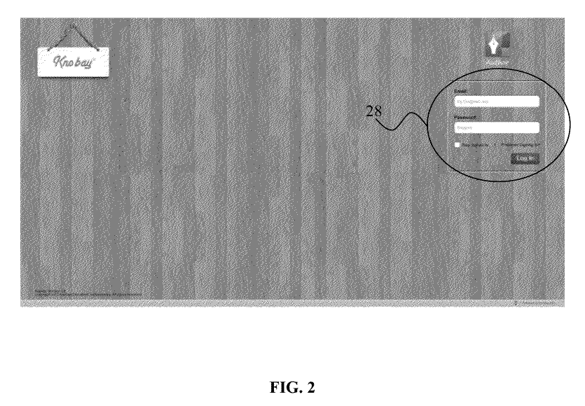

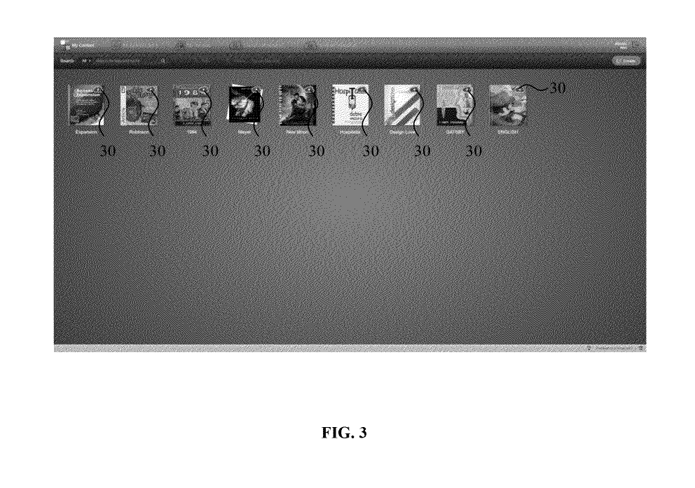

Referring now to FIG. 2, an exemplary login page is shown for a contributor to login to the content delivery system, wherein some standard inputs are required as shown herein by numeral 28. FIG. 3 shows an exemplary landing page after logging onto the content delivery system of the invention. The landing page comprises all the content that contributor has access to at a given point of time. A similar landing page may also be viewed by a user logging onto the system, as will be described herein. The content accessible by the contributor may also indicate whether the content has already been uploaded to a cloud server, or it still needs to be uploaded, as indicated by a suitable icon. An exemplary icon that indicates that the content needs to be uploaded is shown by numeral 30 in FIG. 3.

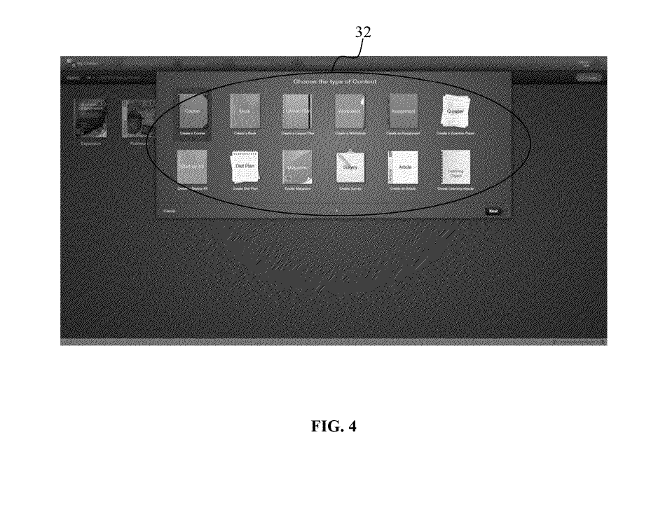

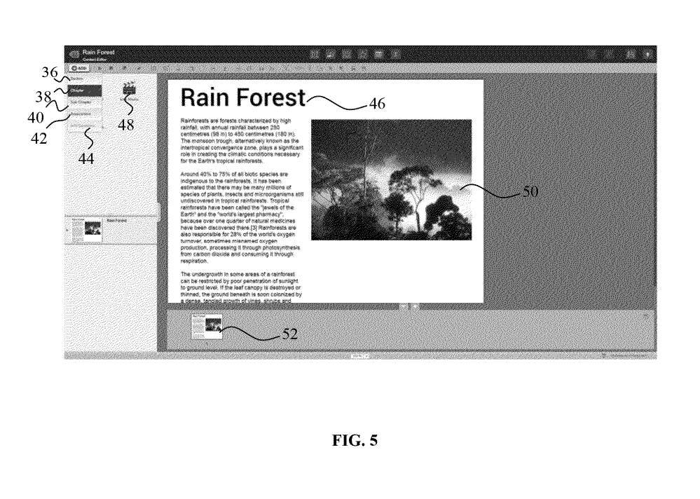

The contributor can then provide content through various means known in the art. In one exemplary embodiment, a predetermined template is provided based on which the contributor builds content for a specific topic, as shown in FIG. 4 by numeral 32. FIG. 5 shows a snapshot of content being created, wherein the content is divided into exemplary portions, namely Section 36, Chapter 38, Sub-Chapter 40, and Assessment 42. Further, the contributor is provided the option of adding questions 44 to the content being prepared to assess a user. The appropriate aspect of the content may then be added, in this exemplary embodiment, a Chapter is being created as depicted by 46. The content delivery system of the invention also provides the option of adding multimedia content by clicking on the suitable icon, shown in FIG. 5 by numeral 48. An image that has been added as a multimedia content is shown by numeral 50 in FIG. 5. A preview is shown at the bottom of the screen, depicted by numeral 52 in FIG. 5, as the content is being created for better clarity of presentation for the contributor. The division of the content into various sub-contents, such as sections, chapters etc. allows for personalization of the content based on a user's requirement. Accordingly, rules can be made and these rules may be personalized to a user depending on the usage data.

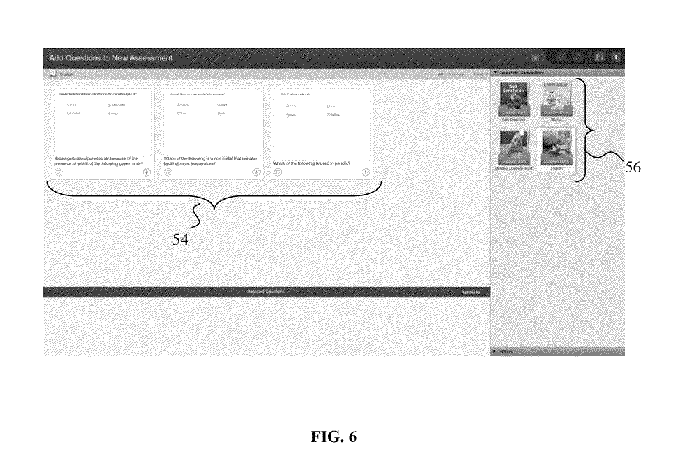

FIG. 6 shows questions being added as part of the content to be uploaded and published. In this exemplary embodiment, a set of questions are added in two different ways. Contributor physically inputs the questions as shown by 54 in FIG. 6. Alternately, questions may be selected from a pre-existing question repository, depicted by numeral 56 in FIG. 6. The questions being inputted in may also be added to the question repository. The questions may then be appended to the appropriate section, chapter, sub-chapter or assessment portion, and thus becomes part of the downloadable personalizable content.

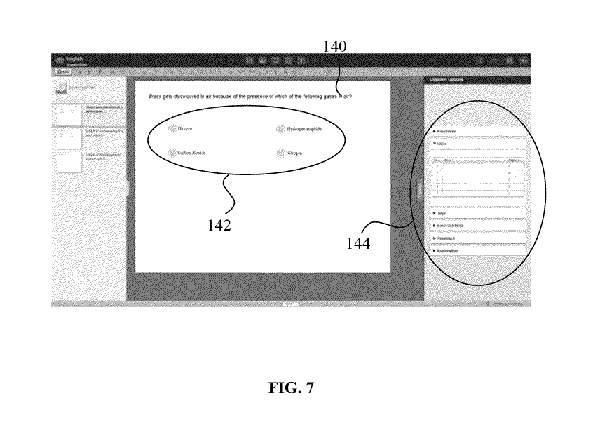

FIG. 7 shows a view of adding questions to the downloadable personalizable content by the contributor. In this instance, for the given question 140, choices 142 are given, wherein each choice is associated with a radio button for the user to choose from while answering. One skilled in the art understand that the radio button may be replaced with a check box, or any other known interactive choices known in the art, all of which are contemplated to be within the scope of the invention. The question is also associated with properties that are being assessed, which can be chosen by the contributor from a predetermined list of options, as shown in FIG. 7 by numeral 144. Properties may include for example, but not limited to, adding explanatory notes related to the question that may be used for later assessment of answers; providing tags for each question that may then be used for grouping of questions related to the same tags or for searching; associating each question with a particular skill such as Knowledge Skill, Soft Skill, etc.; associating each question with a particular domain as defined by Bloom's objectives for learning, which include at the highest level Cognitive, Affective and Psychomotor domains; and so on.

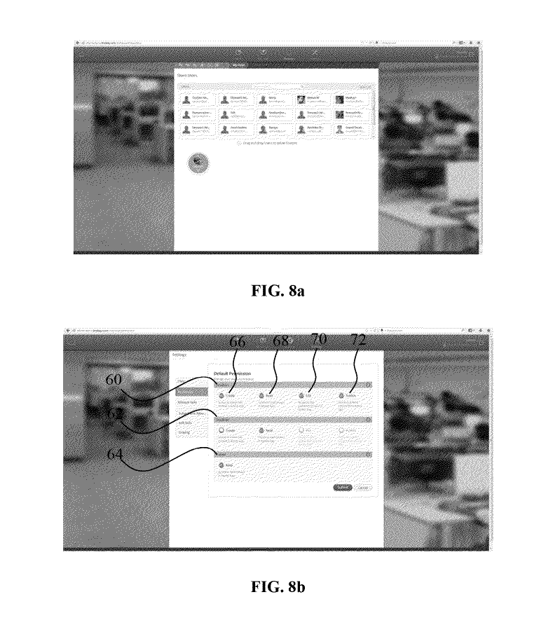

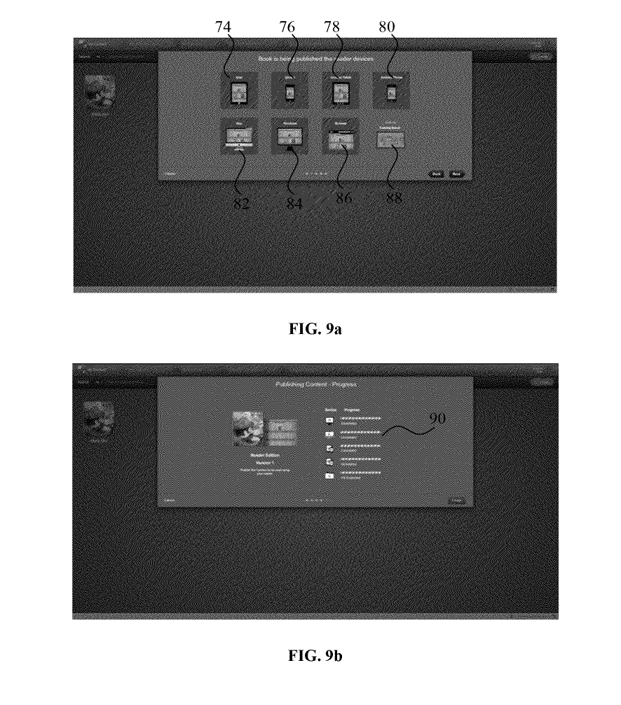

The content can then be offered as a stand-alone downloadable content, or may be classified under a particular subject. FIG. 8a shows one particular subject ‘English’ depicted by numeral 58. Any number of other users can be allowed access to all the content provided under that subject by a simple drag-and-drop action by the contributor or any other authorized member of the system. Alternately, the contributor can permit access to the content created by clicking on users or user groups, as shown in FIG. 8b. The user groups shown in this exemplary embodiment include Teachers 60, Students 62 and Parents 64. The permissions may include, for example, Create, Read, Edit, Publish, as shown in FIG. 8b by numerals 66, 68, 70, and 72 respectively. Then, the created content may be published with an annotation, such as Version 1, and any other comments as contemplated by the contributor. The devices on which the content has to be published may also be determined by the contributor. For example, in FIG. 9a, devices chosen may include Ipad® 74, Iphone® 76, Tablet running on Android™ operating system 78, Phone running on Android™ operating system 80, a PC running on MacOS® operating system 82, a PC running on Windows® operating system 84, any suitable internet browser 86 and a Microsoft® Surface™ tablet 88. The content delivery system of the invention will then provide an update about the progress of the publishing the content, as shown in FIG. 9b, and represented by numeral 90.

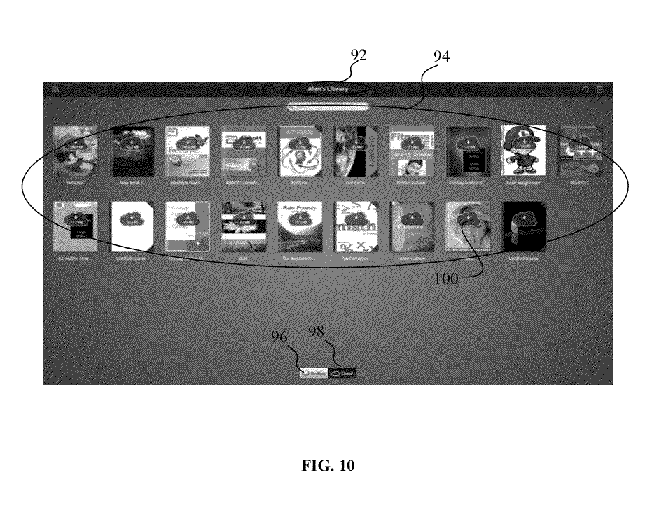

Once the user logs into the content delivery system of the invention as already described herein, the user may be led to a page showing all the content available for consumption. FIG. 10 shows an exemplary page that has a personalized header, as represented by numeral 92. FIG. 10 also shows all the content accessible to the user, indicated by numeral 94. The bottom of the page shows a legend as to whether the content is available on a cloud server 96, or on a local memory device, which in this exemplary embodiment is desktop 98. This legend can then be used to identify whether any content is available on a local machine or on the cloud, as shown by numeral 100 in FIG. 10.

One skilled in the art will recognize that users may be grouped into several classes or categories based on certain criteria. For example, all students in a particular grade may be grouped together, and thus the groups may include Grade 1, Grade 2, Grade 3, etc. Similarly, all students registered for a music class may be grouped together as ‘Music Students’. Further, all students who have excelled in a particular topic may be grouped together as ‘Algebra Heads’. Further such groupings and characterizations will become obvious to one skilled in the art and are contemplated to be within the scope of the invention. The content may then be made available to users in certain groups directly through the content delivery system of the invention.

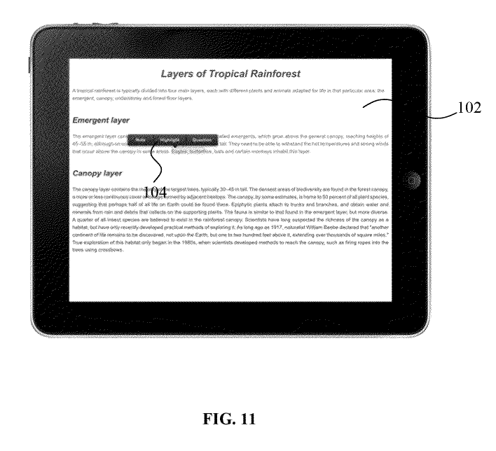

Once the content has been downloaded by a student onto his/her device of choice, it is available for offline use. It can also be appreciated by one skilled in the art that the content may be downloaded by the student in more than one device simultaneously as long as the login credentials permit it. Thus, the content is now available to the student regardless of his/her location, and irrespective of availability of an internet connection. In this manner, all study material related to a student's assigned grade or chosen subjects may be made available for offline study. FIG. 11 shows an exemplary view as seen by the student while studying the chosen topic on an Ipad® device, shown by numeral 102. The content delivery system also allows for highlighting, note-taking and posing queries and questions by the student as already described herein. Appropriate actions to invoke the highlight module and/or the query module include double-tapping, double clicking, pressing and holding onto a certain location, and so on. One skilled in the art will recognize that the exact action will depend on the nature of the device being used. Upon performing the appropriate action, a menu item that includes all the options will appear, as shown in FIG. 11 by numeral 104. Subsequently, choosing ‘Highlight’ will allow for highlighting relevant portions of the content.

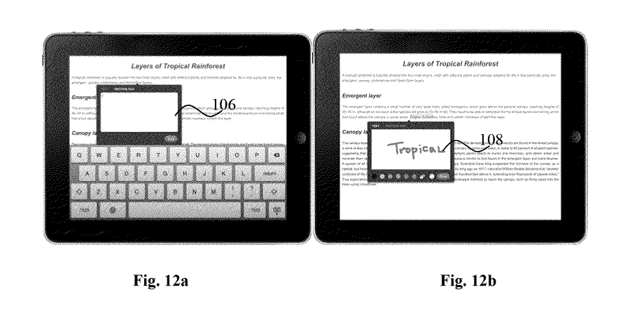

FIG. 12 shows views of the screen of the device when the option ‘Note’ or ‘Question’ is chosen. The student is provided the option of typing the text as a note to self or to pose a question, as depicted by 106 in FIG. 12a. Alternately, a writing pad is invoked as shown by 108 in FIG. 12b wherein the student can handwrite the notes or questions on devices which allow for such inputs.

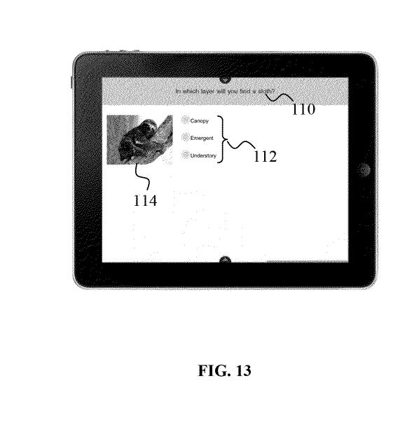

FIG. 13 shows a view of the screen of the device when evaluation criteria for a student are provided. The evaluation criteria in this instance are questions with multiple choices provided for the student to choose to provide the response to the question. FIG. 13 shows a view of a question 110 with three possible choices 112, wherein the question also includes an image 114 associated with the question.

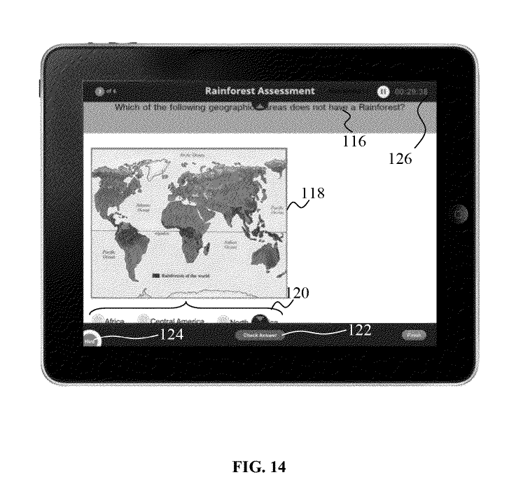

FIG. 14 shows a view of the screen of the device comprising another question 116 that is associated with an image 118. The options for the correct answer 120 are provided at the bottom of the screen. Further, once an answer is provided, the student has the option to check whether the answer provided was right or wrong by pressing the ‘Check Answer’ option 122 provided therein. Also, the student can request for a hint by pressing the ‘Hint’ option 124 provided therein. A timer 126 is provided to assess the time taken by a student to answer the question.

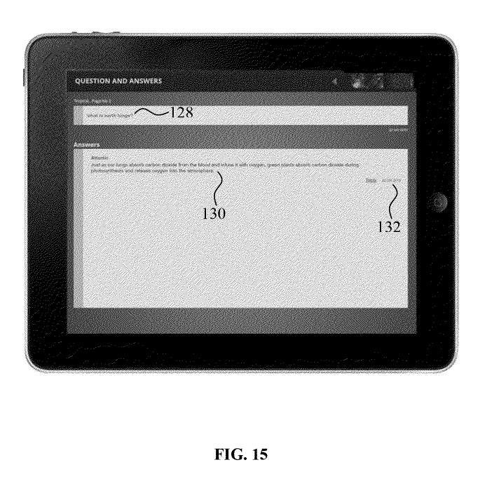

FIG. 15 shows a view of a question 128 posed to the student wherein the response is typed into a text box as shown by numeral 130 therein. The time and date of answering, depicted by numeral 132, is recorded by the usage monitoring module for further later use.

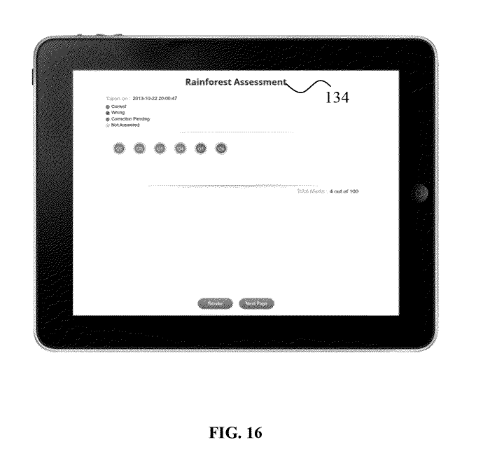

After the student has taken a set of questions, the content delivery system allows for assessment of the student's performance. FIG. 16 shows a view of assessment of a student's performance in one particular topic, depicted by 134. Thus, a student is able make a rapid self-assessment as to the number of correct answers, the number of wrong answers, the number of answers pending correction, and the number of questions not attempted.

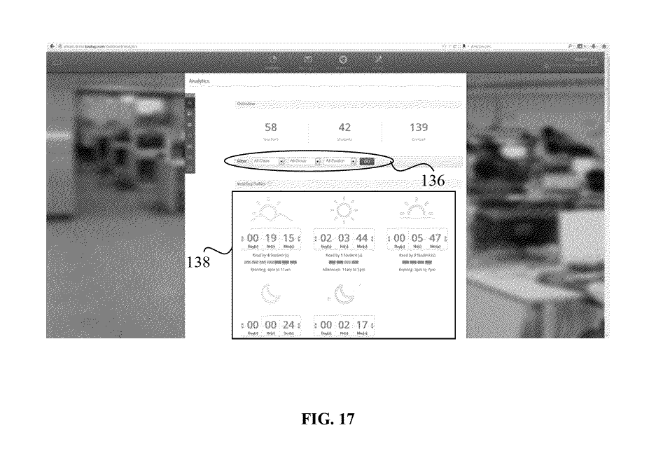

FIG. 17 shows a view of the analytics for a particular group of students. The data from the usage monitoring module may be filtered by several criteria, which criteria may be selected through at least one drop down menu, shown by numeral 136 in FIG. 17. In this exemplary view, the reading habits of students as to the preferred time of day they study are shown, represented by numeral 138 therein. This information may then be used to identify suitable time frames for content delivery customized for each student so as to ensure timeliness of availability of content.

In another exemplary embodiment of the content delivery system of the invention, members of a particular gym may be given access to workout plan routines, wherein each workout plan routine is based on some basic evaluation performed by a suitable gym employee such as a specialized trainer. The basic evaluation may include assessing a BMI, or other such evaluation. The evaluation may further include the goal desired by the gym subscriber. Subsequently, a personalized content is provided to the gym subscriber, wherein the content may include daily exercise routines, diet plans and other such relevant information. The content may further include reminders and alarms to remind the gym subscriber that the time for performing a particular exercise is due. The actual exercises to be performed by the gym subscriber may be actually performed at any suitable location, and not necessarily at the gym itself. This makes it highly convenient for the on-the-move busy schedules felt in the current day professional. However, by not going to the gym itself, there is no compromise in achieving the final goal from the gym routines. After a certain time period has lapsed, a questionnaire may be provided for the gym subscriber to answer. Based on the answers provided, the exercise routine and diet plan may be suitably modified, which personalized content is provided to the gym subscriber. Further, based on the analytics, the personalized content may be delivered at the most preferred time to ensure that the content will not be missed out despite the busy schedules.

Thus, the content delivery systems of the invention may offer downloadable personalized content to a user from a wide range of fields for consumption by the users regardless of their immediate connectivity status. The content may be downloaded at any particular time chosen by the user or be downloaded at a predetermined time based on usage statistics and other criteria for each user without being too intrusive to any user, while also taking into account aspects such as available bandwidth for more efficient delivery of content. The content delivery system also enables collaboration among peer groups, or conferencing with another user of supervisor or teacher, depending on the environment. The collaboration may occur without the need for invoking another program such as an electronic mail or an instant messenger, which may or may not be compatible with some or all of the features present within the content delivery system. The content delivery system of the invention provides a powerful tool for imparting knowledge across a wide variety of platforms for a variety of different users, including many different learning environments.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A content delivery system comprising:
a content module comprising downloadable personalizable content for offline access by a user;
a usage monitoring module to obtain usage data;
an evaluation module to obtain evaluation results for the user, wherein the evaluation results includes usage data;
a content personalization module to provide personalized content from the downloadable personalizable content to the user, wherein the personalization is based on the evaluation results from the evaluation module; and
a storage module to store at least one of the downloadable personalizable content, the usage data, the evaluation results, the personalized content and combinations thereof for offline use,
communication module to upload at least one of the downloadable personalizable content, the usage data, the evaluation results, the personalized and combinations thereof for online.

2. The content delivery system of claim 1 wherein the usage data comprises at least one of offline use, online use, or combinations thereof.

3. The content delivery system of claim 1 wherein the content is provided on a cloud server.

4. The content delivery system of claim 3 wherein the content is provided by a content provided and is prepared offline and uploaded onto the cloud server.

5. The content delivery system of claim 1 further comprising highlight module configured to highlight at least a portion of the downloadable personalizable content.

6. The content delivery system of claim 1 further comprising a query module to pose a query by a first user to one or more other users.

7. The content delivery system of claim 6 wherein the query module is made available offline, online or both, wherein the when the query module is invoked offline, then the query is posed to the one or more other users when the first user is online.

8. The content delivery system of claim 1 wherein the user is a student.

9. The content delivery system of claim 1 wherein the content provider is at least one of editors, proofers, publishers, authors, copy-editors, illustrators, animators, teachers, subject experts, peers, reviewers, students, and combinations thereof.

10. The content delivery system of claim 1 configured to provide the downloadable personalizable content, the personalized content, and combinations thereof to a set of specific assigned users.

11. The content delivery system of claim 1 further comprising a publication module that is configured to publish the downloadable personalizable content on any device by including device-specific renderable objects in one or more target platform-dependent representations of the downloadable personalizable content.

12. The content delivery system of claim 1 wherein the downloadable personalizable content is rendered searchable.

13. The content delivery system of claim 1 wherein the downloadable personalizable content is capable of being rendered in an electronic format suitable for publication in paper form.

14. The content delivery system of claim 1 further comprising an analytics module.

15. The content delivery system of claim 1 wherein the downloadable personalizable content comprises at least one evaluation criteria.
